(19) United States
(12) Patent Application Publication
(10) Pub. No.: US 2007/0243422 A1
(43) Pub. Date: Oct. 18, 2007

(54) METHOD FOR PRODUCING PRINTED CIRCUIT BOARD STRUCTURES COMPRISING VIA HOLES, ELECTRONIC DEVICE UNIT, AND USE OF A FLEXIBLE STRIP CONDUCTOR FILM IN THIS DEVICE

(75) Inventor: Georg Busch, AHAUS (DE)

Correspondence Address: BELL, BOYD & LLOYD, LLP, P.O. BOX 1135, CHICAGO, IL, 60690, US

(73) Assignee: SIEMENS AKTIENGESELLSCHAFT, MUENCHEN (DE)

(21) Appl. No.: 11/571,590

(22) PCT Filed: Jun. 21, 2005
(86) PCT No.: PCT/EP05/52881

§ 371 Date: Mar. 29, 2007

(30) Foreign Application Priority Data
Jun. 30, 2004 (DE) 10 2004 031 729.1
Jun. 30, 2004 (DE) 10 2004 031 718.6
Jun. 30, 2004 (DE) 10 2004 031 730.5

(51) Int. Cl. B05D 5/12

(52) U.S. Cl. 428/901; 427/96.1

(57) ABSTRACT

A method is proposed for producing printed circuit board structures with possible realization options including adhesiveless, flexible and with the smallest via holes with diameters for example of the order of magnitude between 1 and 5 μm. The method is based on a supporting means for the circuit board structure which is still without any copper cladding. The passage holes are shot through or lasered especially for the smallest via holes with the aid of heavy ions or a precision laser in the supporting material provided on its own in this way. The surface of the supporting means is not clad with copper until after this process. When this is done the electrical via holes are contacted simultaneously. If the supporting means is for example flexible polyimide and not yet preprocessed for copper cladding, the surface of the supporting means can be roughened at the same time as the holes are made by controlling the intensity of heavy ion acceleration or the precision laser appropriately. Subsequently the desired circuit board structure is then provided by conventional methods. Furthermore an electronic device unit and the use of a flexible strip conductor film in such a device unit is proposed, with in each case a flexible strip conductor film being used, which is formed with passages through the film which are passages treated at least originally by heavy ion bombardment.

### FIELD OF TECHNOLOGY

The present disclosure relates to a method for producing printed circuit board structures having via holes. The disclosure further relates to an electronic device unit with a dedicated function, featuring electronic circuits and/or electronic functional components and also featuring, for the interconnection of the circuits and/or electronic function components, at least one single strip conductor support, and additionally relates to a flexible strip conductor film for use in such a device unit.

### BACKGROUND

In methods for producing dual-layer or multilayer circuit board structures, via holes in general and especially micro via holes in the smallest space with a pad diameter of less than 200 μm represent a problem. As for an example, micro vias with a hole diameter of 75 to 100 μm and a pad diameter of 250 to 300 μm are types of structures contemplated in the art.

A corresponding specification can be found in documentation published by P. C. M. GmbH, Hattsteiner Allee 17, 61250 Usingen, URL: http://www.p-m-c.DE/Produkte/Standardleiterplatten/tech-rdllp_d.htm.

In addition for production of circuit supports with closed via holes and small layer thicknesses, it is generally known that the via holes are to be incorporated or to be seeded into a film coated with copper on both sides. Subsequently copper is applied which may also be further electrically strengthened. After a photosensitive layer has been applied, the conductive pattern is applied using a transparency. A resist is used as etch protection for the conductive pattern. In further process steps, the conductive pattern is etched and the etch protection is removed again.

This means that the production costs of such circuit board structures are relatively high.

A method and an arrangement for processing supporting material by heavy ion bombardment and subsequent etching process is known from document WO 2004/015161 A1 which is incorporated by reference herein, wherein a process is used to roughen the surface of a supporting means of a circuit board structure or of the supporting material of the circuit board structure, so that a copper layer to be applied subsequently adheres securely to the appropriately processed surface of the supporting means or of the supporting material.

The roughening of the surface is especially important if the copper layer is applied without an adhesive to the supporting means or supporting material and if, for example, the supporting means or supporting material is a plastic such as polyimide for example.

Polyimide (PI) is used for high-quality circuit board structures which are bendable, i.e. flexible. Other examples of such a supporting means are polyethylene napthalate (PEN) or Polyester (PET). For rigid circuit board structures CEM 1, FR2 or FR4 can be used as the supporting means for example.

Previous production processes for the production of circuit board structures supporting means have been used which are already copper-coated at the point of implementing the via holes. The result of this is that, during production of the electrical via holes, a further copper layer is applied at least in some places, through which the thickness of strip conductors of the circuit board structure eventually produced is increased. In addition this means that the expense of applying the first copper layer is redundant since it can be replaced by the second copper layer application.

A further disadvantage is that the overall thicker copper layer obtained only allows a coarser strip conductor structure than a thinner overall copper layer. In addition an attempt is to be made to achieve a further reduction of the space required for the via holes so that for example more holes than before can be accommodated on a predetermined surface of the circuit board structure.

Also known are device units with flexible strip conductor film, which within the line structure formed by the strip conductors arranged on the film, connection points are provided at which connections between individual strip conductors of the line structure or between strip conductors of the line structure and electronic circuits or other electronic functional components are produced. Examples of such device units are flexible displays and cordless or mobile telephone devices which either have such flexible displays with flexible strip conductor film or have flexible strip conductor films as well. In addition development is currently moving towards device units which are ever smaller and/or have ever more complex functions.

The result of this latter development is that the inner structures of such device units become ever finer and smaller. This relates to a particular extent to the line structure of strip conductor films, in which case, within the aforementioned line structure, locations are embodied at which connections between individual conductors of the line structure or connections to electronic circuits or other electronic functional components are implemented. These locations can, for example, be embodied for this purpose as via holes or exclusively as a connection point. However a combination of the two given measures for selected locations is also possible. In such cases a maximum number of such connecting points are often needed in the very smallest space.

Via holes are based on passages made in the strip conductor film. Connection points are based on small connection surfaces of a predetermined size which will also be referred to as pads. The selected diameters of the passages or of the pads associated with them or of the pads per se determine the maximum number of via holes or connecting points which can be arranged within a predetermined unit of space. With increasing miniaturization of the device units, but also with increasing complexity of the circuits needed within the device units, the need for a high number of pads or via holes arranged within such units of space increases, small diameters for the via holes or the pads are important.

Currently technical holes or passages with diameters in the range of 20 nm and greater can be produced. This can be achieved with methods in which a heavy ion bombardment or precision laser treatment is undertaken. These holes or the respective sets of holes at the respective desired locations obtained in such cases can be expanded by means of a downstream etching step to holes of predetermined sizes. A possible size for the selected expansion can for example be between 1 and 5 μm. It can however also be selected to be smaller or larger. The size quoted already represents a very small size. In many cases the holes or vias can for example be expanded to 20 to 40 μm and combined with pads in the order of magnitude of 75 to 150 μm. This means that connection points based on this are still significantly smaller than those which are produced with conventional methods. This allows connection points with the density at least in the order of magnitude of 150 to 300 DPI to be realized.

A method for creating printed circuit boards is known from document DE 198 35 158 A1, which is incorporated by reference herein, in which, at points at which a via hole is to be provided, at least one single hole is made with an appropriate hole-making method. The proposed methods of making a holes are laser drilling and, instead of laser drilling, mechanical drilling. The laser drilling and mechanical drilling are placed alongside each other here. The results of the two methods are thus also to be seen alongside one another. Since the results of mechanical hole drilling are coarser, the results of laser drilling are to be seen as also being coarser. However this does not refer to precision laser drilling, which at least provides the opportunity of making a single hole at locations at which a via is to be provided.

A method for producing printed circuits is also known from document U.S. Pat. No. 3,904,783, which is incorporated by reference herein, of which the decisive point is the use of a specific material for covering the surface of the printed circuit at specific stages of the process. The circuits also include via holes. However in particular the document does not say anything about how and in what embodiment the holes for the vias are drilled.

A method for processing supporting films by bombarding them with heavy ions is known from document DE 100 58 822 A1 which is incorporated by reference herein, with this bombardment merely acting as a basis, in conjunction with a subsequent time and speed-controlled etching step, to create a desired surface depth relief in order in turn to attach a further layer mechanically to this. A penetration of the heavy ions is definitively excluded. This means that this prior art does not go beyond the prior art in accordance with document WO 2004/015161 A1 already mentioned at the start.

Methods with heavy iron bombardment of different materials, which are also penetrated, are known from the documents DE 33 37 049 C2 and DE 200414892 36 743 196 50 881 C2 each of which is incorporated by reference herein. The penetration, however, does not relate to the production of vias per se, but to the production in general of different conductivities of the material in directions at right angles to each other. In this case adjacent penetrations should basically remain individual penetrations.

A method is known from document US 2002/000370, which is incorporated by reference herein, in which via holes are made by laser drilling in a substrate such as Polyimide for example. Subsequently an etching process is performed for removing debris and a copper cladding process is undertaken.

A method is known from the document “Removal of Polyimide Laser Etch Debris by Wet Etching” by an unknown author, IBM TECHNICAL DISCLOSURE BULLETIN, Bd. 36, No. 2, 1. Feb. 1993 (1993 Feb. 1), pages 439-440, XP002350794 New York, US, in which holes are made by laser drilling in a polyimide substrate. When these holes are made debris is produced on the walls of the holes by the laser drilling. To remove this debris an etching process using a KOH solution is undertaken after the laser drilling. It is further known from said document that such an etching process not only removes the debris but also enlarges the holes.

### BRIEF SUMMARY

An exemplary embodiment discloses a method for producing a circuit board structure featuring a via holes of the type mentioned previously which has a simplified production process and is thereby cheaper, which allows the production of the smallest vias and which also is usable with circuit board structures which are produced without adhesive and are flexible.

Another exemplary embodiment discloses a device unit of the type mentioned previously such that an increase in the miniaturization and/or in the degree of complexity of the functions able to be performed by a device unit while maintaining or improving the cost factor is achieved. A further embodiment discloses the use of such a flexible strip conductor film in a corresponding device unit.

### DETAILED DESCRIPTION

At the time of production of the via holes, supporting means are used which do not yet have a copper layer on their surfaces. This means that the production steps up to this point in time are omitted such as are necessary to apply these layers to the supporting means. In the final analysis this simplifies the overall method of producing the circuit board structure.

Before any layers are assembled, at the locations provided for via holes in the subsequent circuit board structure, a single hole is made with a hole-making method which is a heavy ion bombardment and/or a precision laser treatment, to make at least one single hole in each case at a respective location concerned. This means that the via holes produced are formed in each case from a single, but generally from many smallest passages.

Under some circumstances, in addition to the heavy ion bombardment and/or precision laser treatment, the technique of laser drilling or mechanical hole drilling can also be used. The heavy ion bombardment or the precision laser drilling has the particular advantage of enabling the very smallest vias to be implemented.

With the aid of a subsequent etching process the fabricated holes can be etched out to a desired dimension. In this case, if, for example, the hole-making method used includes the fact that at a predetermined point more than one individual hole will be made at the same time within a predetermined environment, as is, for example, possible with bombardment by heavy ions, a number of holes lying in close proximity to each other may if necessary be expanded into a single larger hole of the desired size. Overall, however, these final holes also then have a typical hole diameter of between 1 and 5 μm, which currently represents the smallest hole practically possible for a via.

Covering the surfaces of the supporting means or the supporting material of the circuit board structure with copper is only undertaken in a subsequent method step. In this case the simultaneous electrical through-contacting between the copper layers through the holes made in the previous method step is undertaken. This method step should be conducted in each case, because otherwise the vias would not be usable electrically, and measures which provide an already copper-clad supporting means beforehand are redundant. This redundancy is avoided with the method presented here.

Since no copper layers were yet present previously the thicknesses of the copper coverings are also minimal. High-precision strip conductor structures can thus be fabricated with these copper claddings.

In addition the small diameters of the vias, on establishing the electronic through-contacting, are filled completely with copper and also have a flat surface.

This is advantageous as regards the flow of maximum current densities through these vias and is advantageous in retaining a flat surface of the supporting means without the additional effort of further operating steps.

Otherwise the holes would have to be filled completely in additional operating steps and their ends ground down flat.

When larger holes are filled, and these would then be the vias if they cannot be completely filled immediately by the copper cladding, raised caps are produced at the ends of the vias. Only when the vias are filled and flat at the ends can the surfaces located on them be used for example for strip conductors or in any form for any other circuit constructions. Such uses should however be made possible in the preceding method steps. In other words with the specified method steps, with minimum effort, an overall maximum utilization of the space of the surface of the supporting means of the circuit board structure and additionally the use of finest structures is possible in this context. This makes it possible for example to reduce the size of the circuit board structure and/or to increase the level of complexity of the circuit construction realized on it respectively.

Finally the further method steps also already known can be executed in order to finally obtain the complete circuit board structure desired.

Since the vias are very small, correspondingly increased numbers of vias can be provided on a predetermined surface of the supporting means or of the circuit board structure. This is especially advantageous if the circuit board structure is to be used for example for new types of displays with very high through to extremely high resolution. Such displays correspondingly require extremely large numbers of connections in the smallest space. Another example is the provision of vias for power supply strip conductors for example. It is a simple matter to produce a number of vias alongside each other for this purpose which then for example can be connected in parallel with, at their ends, correspondingly sized pads which are still however very small overall.

Before copper cladding is performed on the sole supporting means, that is on the supporting means without any copper which means without any copper cladding or other copper strip conductors, the conductor image is structured and activated for the subsequent step. Then, in a chemical copper application process, copper is applied to the activated circuit image, in which case the vias are through-contacted at the same time. This saves one process of laminating copper onto the surface and the circuit board structure is created immediately.

The advantage of applying this method is that the production costs are comparable with current films which are supplied as raw-material coated with copper on both sides and without vias and without circuit structure

Furthermore heavy ion bombardment can be used as the hole production process, as already discussed above. This allows the smallest vias to be realized, as also already stated above. If vias which are not quite so small are needed, the holes can also be created using a laser method or a high-precision laser method respectively. If the via holes can be even coarser, the holes can also be made using a conventional drilling method.

Also advantageous is the use of flexible materials such as polyimide as a supporting means since flexible circuit board structures can be produced with this material for example. This can even be done while using the smallest vias and the finest strip conductor structures. The smallest vias are significantly smaller than previously known vias. For their part they have the advantage of filling up completely when electrical through-contacting is undertaken, with flat surfaces at their ends. They can therefore be accommodated in the smallest terminals of BGA (Ball Grid Array), CSP (Chip Size Packaging) or flip-chips.

If there is a need for copper strengthening of strip conductors which can for example be the case with power supply strip conductors, this can still be easily undertaken with conventional methods.

Another advantage is that the method step of roughening the surface of the supporting means to prepare the adhesion base for the copper cladding does not have to be undertaken in advance but can be performed along with the heavy ion bombardment or precision laser treatment of the supporting means for the production of the passages or the via holes. This can be done, for example, by fabricating the passages at the locations provided and at the remaining respective locations by controlling the intensity of the heavy ion bombardment or of the precision laser treatment in another way to just roughen the surfaces of the supporting means. The roughening is undertaken by the heavy ions or the precision laser at least penetrating into the surface of the supporting means at the locations concerned.

The option of roughening up the surfaces of the supporting means has the associated advantage that the copper cladding of the circuit board structure can be applied without adhesives.

The etching-out process for etching out the holes to a desired size can be controlled in a very simple manner depending on the process time for the etching. In this case it is easy to check that the hole sizes of the vias are of the order of magnitude of between 1 and 5 μm. In addition it is a simple matter to connect vias in parallel with the aid of correspondingly sized pads over the vias.

An electronic device unit which executes a specific function or functions in accordance with the present disclosure has electronic circuits and/or electronic functional components as well as at least one strip conductor support for connecting the electronic circuits and/or electronic function components, and uses at least one single such strip conductor support which is formed by a flexible strip conductor film which, for the connection of electronic circuits and/or electronic functional components, features connection points with or without film vias and/or film vias connecting strip conductors, which are formed with film vias which are passages at least originally created by heavy ion bombardment or precision laser treatment.

Regarding use of a flexible strip conductor film featuring film vias in electrical device units, the stated advantages are achieved by the use of such a flexible strip conductor film which features the vias which are formed by passages through the film which are passages originally created at least by heavy ion bombardment or precision laser treatment.

Regarding the electronic device unit and the use of a flexible strip conductor film, the advantages are produced by the fact that the flexible strip conductor films can be produced at low cost and that they can be used either to realize circuits in the smallest space, meaning miniaturized, or with a correspondingly lower degree of miniaturization correspondingly more complex circuits or circuit functions can be connected.

If for example previously used rigid displays are to be replaced by more flexible displays for fixed or mobile applications, previously rigid displays have been used of which the glass surfaces have been made so thin, using greater effort and expense, that they can be curved in a slight arc. The costs of such displays are greatly increased by the thinning process. In addition only bending radii greater than 1 m can be realized in such cases.

Flexible strip conductor films are also cheap to produce. In addition they can be processed with heavy ions and precision laser treatment. This allows strip conductor structures to be implemented which can be embodied to be far smaller or can be used for far more complex circuits or circuit functions. As already mentioned above, resolutions of 150 to 300 DPI and less can be implemented.

This is important if small and very small displays with significantly greater resolution and significantly finer contrast are to be implemented.

Accordingly the inventive measures disclosed herein may be implemented in conjunction with flexible displays and in conjunction with cordless or mobile telephones in which corresponding displays are used. In addition the inventive measures may also be used wherever flexible strip conductor films are employed.

With flexible displays, the degree of miniaturization or the complexity of the circuits and circuit functions is increasing, since for example the resolution and the contrast are to be improved all the time.

While the invention has been described with reference to one or more exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the appended claims.

1-12. (canceled)

13: A method for producing a printed circuit board structure, said method comprising the steps of:
processing, in a first step, a supporting structure of the circuit board structure at a point provided for a via hole, wherein the processing comprises creating a hole through the point using one of ion bombardment and laser drilling;
performing an etching process on the sides of the supporting structure containing said hole in a second step, wherein the etching process expands the hole to a desired size;
performing a copper cladding process in a third step, wherein an upper and lower surface of the supporting structure is formed, and wherein the copper cladding process simultaneously produces an electrically conductive via hole.

14: The method according to claim 13, wherein, before the copper cladding step is performed, a conductor configuration is arranged on the supporting structure, wherein a chemical copper application process is applied to the conductor configuration in which the via hole is through-contacted.

15: The method according to claim 13, wherein the supporting structure is a polyimide film.

16: The method according to claim 13, wherein, during the one of ion bombardment or laser drilling, a roughening is simultaneously performed on a side of the supporting structure affected by the one of ion bombardment or laser drilling.

17: The method according to claim 16, wherein the one of ion bombardment or laser drilling penetrates the surface of the supporting structure to perform said roughening.

18: The method according to claim 13, wherein the circuit board structure is an adhesiveless circuit board structure.

19: The method according to claim 13, wherein the etching process is performed as a function of time.

20: The method according to claim 13, further comprising the step of electrically connection the via hole to a second electrically conductive via hole in parallel above and below each via hole on the upper and lower surface of the supporting structure with the aid of pads.

21: The method according to claim 13, wherein the etching process expands the hole to a size between 1 and 5 μm.

22: An electronic device, comprising:
a plurality of strip conductors;
a single strip conductor support, which is formed by a flexible strip conductor film, said conductor support comprising connection points for connecting the strip conductors, wherein the connection points that are formed by passages created by one of ion bombardment and laser drilling.

23: The apparatus according to claim 22, wherein the connection points include film via holes

24: The apparatus according to claim 22, wherein the connection points include via holes

25: The apparatus according to claim 22, wherein the electronic device is a flexible display.

26: The apparatus according to claim 22, wherein the passages are 20 nm or greater
